(19) United States
(12) Patent Application Publication
(10) Pub. No.: US 2026/0249572 A1
(43) Pub. Date: Aug. 27, 2026

(54) A METHOD OF REPAIRING PIPE AND TANK SURFACES USING POLY FILL AND PTFE COATED E-GLASS FABRIC

(71) Applicants: Donald W. MEYERS, Newark, OH (US); Praveer REDHU, Waukesha, WI (US)

(72) Inventors: Donald W. MEYERS, Newark, OH (US); Praveer REDHU, Waukesha, WI (US)

(21) Appl. No.: 19/546,667

(22) Filed: Feb. 23, 2026

Related U.S. Application Data
(60) Provisional application No. 63/763,408, filed on Feb. 26, 2025.

(51) Int. Cl. B29C 73/10; B29K 27/18; B29K 105/00; B29K 309/08

(52) U.S. Cl. CPC B29C 73/10; B29K 2027/18; B29K 2105/256; B29K 2309/08

(57) ABSTRACT

The present invention relates to a method of repairing pipe and tank surfaces using a poly fill and coated fabrics. The invention relates to a method of repairing pipe and tank surfaces by applying a poly fill and PTFE coated e-glass fabric patches or wraps to both synthetic polymer and/or non-synthetic polymer pipe and tank surfaces. The method utilizes a synthetic polymer preparation solution to prepare the synthetic polymer surface for the molecular integration, a polymerization catalyst as well as a heating source for activating and accelerating the molecular integration process, and a surface-insensitive bonding agent formulated to react with the pipe or tank surfaces for a more consistent, and reliable molecular integration.

### FIELD OF INVENTION

The present invention relates to a method of repairing pipe and tank surfaces using poly fill and PTFE (Polytetrafluoroethylene) coated e-glass fabric. Particularly, the present invention relates to a method for repairing damage in pipes, tanks, etc. by applying a PTFE coated e-glass fabric patch or a PTFE coated e-glass fabric wrap to restore structural integrity, seal holes and cracks which restore usability of damaged pipes. A poly fill comprising of polymer micro-balloons and a catalyst can be used to fill cracks in the pipe substrate and/or to increase the strength and durability of the patches and wraps. This invention can be used on both synthetic polymer and/or non-synthetic polymer pipe and tank surfaces to restore the structural integrity of damaged surfaces, or to create a poly sheet that restores the surface of damaged pipes and tanks.

### BACKGROUND OF THE INVENTION

Glass fabric is composed of glass fibers produced by the high-temperature conversion of borosilicate and other mineral raw materials into a homogeneous molten mass. The molten material is then extruded or drawn into continuous glass filaments, which are subsequently woven into a flexible fabric. The woven glass fabric is then coated with multiple layers of PTFE (polytetrafluoroethylene) to form a composite material.

Glass fabric has exceptional strength and durability. Multiple wraps of the glass fabrics can reach 37,000 psi or higher. Glass fabric is not sensitive to changes in temperature and is an excellent insulator due to its surface area to weight ratio. Glass fabric has excellent resistance to chemicals, gasoline, oil, biological agents, aromatic fuels, oxidizing agents and is inert to heat.

Once woven, multiple layers of PTFE coating are applied. PTFE has excellent resistance to chemicals, oil, gas, solvent, aromatic fuels, acids, bases, and excellent UV resistance. PTFE’s carbon-fluorine bonds are about 30% stronger than the carbon-hydrogen bonds found in other plastics. Having the PTFE coating on the glass fabric substantially increases the durability of the bond.

PTFE, as a polymer, has a nonstick surface. In order to bond the PTFE coated glass fabric to polymer surfaces and non-polymer surfaces, polymerization must occur.

Polymerization is the chemical process of combining smaller molecules, called monomers, into a chain held together by covalent bonds. Various chemical reactions caused by heat or by a combination of heat and a chemical reaction result in polymerization. For example, with HDPE pipe, heat alters the molecular structure of the monomers. These molecules speed up and separate. If each end of two HDPE pipes are prepped with an adhesion promoter and the two pipe ends are warmed, then the ends of the pipes can be joined with a chemical reaction.

Currently, the process of heating the ends of HDPE pipe to where the two ends can be joined together is called fusion welding. However, fusion welding faces some problems, as the success in fusion welding is limited to bonding similar types of substrates only. In addition, because of the high heat needed without a catalyst, fusion welding often causes cracking in the HDPE pipe.

The present invention allows the bonding of synthetic polymer substrates whether the polymers are similar or not. The present invention bonds the cracked ends of HDPE pipe up to 12 inches in diameter and the bond will withstand the pressure rating of 4 inch diameter, SDR 11 pipe. If the pipe is applied with the two layers of Tech Patch and then the Poly Fill, the pipe will not break.

In addition, the present invention also works with non-polymer substrates, such as steel, copper or rubber. To be effective on high pressure pipes or tanks, a Tech Wrap may be used. Tech Patches and Tech Wraps are flexible so that it can be applied to the curvature of the pipe or tank. Patches and wraps will be durable as various industries demand a repair last for at least five to ten years or, in all probability up to the life of the pipe, before replacement is required. Vinyl is an example of a flexible patch but it is not durable.

Oftentimes pipes or tanks develop cracks or fractures, which require some type of repair. For example, HDPE pipes often have weak points that begin to show damage, copper pipes may develop pin hole leaks, or a steel storage tank might experience wall thinning due to corrosion. Currently, for HDPE, or copper pipes, the only means of repair for each of these problems is replacement and no technology exists that will bond a permanent patch over the damaged pipes or tanks effectively. For thin walls in steel storage tank, the only means to repair such problem is by welding a steel plate over the thinned area but welding a steel plate on a steel wall leads to embrittlement.

Several prior art documents have disclosed various approaches to address the challenges associated with polymer surface repair and bonding.

US Patent No. 10,577,521 B2 discloses a polymer bonding process that provides compositions and kits having instructions for using the compositions for providing a bond between synthetic polymers or between a synthetic polymer and another type of substrate. The method involves applying a synthetic polymer preparation solution to synthetic polymer surfaces, followed by application of a polymerization catalyst, heating the surfaces to temperatures between about 114°-120℉ (47-49℃), applying a surface insensitive cyanoacrylate structural adhesive, and urging contact between the surfaces. The synthetic polymer preparation solution comprises quantities of hydrotreated light naphtha, isopropanol, and triethylenediamine, while the polymerization catalyst comprises an amine such as N,N-Dimethyl-p-toluidine mixed with a carrier that flashes off quickly, usually acetone.

US Patent No. 11,603,482 B2 which is a continuation-in-part of the '521 patent, extends the polymer bonding technology to patching applications. This patent provides methods and compositions for patching a polymer or a non-polymer substrate surface by producing a bond between a polymer patch surface and the substrate surface. The method includes steps of roughing the polymer substrate surface, cleaning the surface, applying the synthetic polymer preparation solution, allowing it to dry, applying a polymerization catalyst, heating the surface until temperatures reach between about 114°-120℉, applying a surface insensitive cyanoacrylate structural adhesive to the polymer patch surface, and urging contact between the surfaces. The patent specifically discloses that the polymer patch surface is manufactured of fluorosilicone and has been treated with polyfluoroalkyl substances and abraded to provide a matte finish.

US Patent No. 7,938,146 B2 discloses a repair apparatus and method for pipes and fittings utilizing fabric-like material intermixed with adhesive. The method involves exposing and cleaning the compromised section, abrading the surface, and applying layers of adhesive that cure to a semi-rigid state, followed by fibrous material application. This method does not work well on HDPE polymer pipes and tanks. This methodology is not practical to use on walls.

CA-2950056-A1 describes repair methods for pipes including breach coverage using conformable materials capable of carrying curable polymers. The method involves preparing pipe wall surfaces around breaches, sizing conformable material pieces, and applying them with curable polymers to seal against groundwater infiltration. However, this prior art is limited compared to the present invention in several aspects. It focuses primarily on groundwater infiltration prevention rather than comprehensive surface restoration using poly fill technology. Again, this prior art does not work well oh HDPE pipes and tanks. This methodology also is not effective on walls or large tanks.

International Patent Application Publication No. WO 2021/141609 A1 to Meyers discloses a polymer bonding process similar to the aforementioned patents, focusing on producing permanent bonds between synthetic polymer surfaces and substrate surfaces. The application describes the use of synthetic polymer preparation solutions, polymerization catalysts, and surface insensitive cyanoacrylate structural adhesives in combination with controlled heating to achieve strong, permanent bonds.

While these prior art documents have made significant contributions to the field of polymer bonding and repair, they possess several limitations when applied to pipe and tank surface repair applications. The prior art methods are primarily focused on general polymer bonding and patching applications but do not specifically address the unique challenges associated with pipe and tank repairs, such as the need for pressure resistance, chemical resistance, and long-term durability in industrial environments. The prior art documents do not disclose the use of PTFE coated e-glass fabric patches or wraps, which provide superior chemical resistance, durability, and flexibility necessary for pipe and tank applications. The prior art methods do not provide solutions for restoring lost corrosion allowance in steel storage tanks without welding, which is a critical need in the oil and gas industry.

In view of the problems associated with the above state of art, there is a need to develop a quick, effective, efficient method facilitating bonding of PTFE coated e-glass fabric patches or wraps and poly fill comprising of polymer micro-balloons and a catalyst to polymer and/or non-synthetic polymer pipe and tank surfaces.

### SUMMARY OF THE INVENTION

The present invention relates to a method of repairing pipe and tank surfaces using a poly fill and PTFE coated e-glass fabric. The invention relates to a method for repairing damages in pipes, tanks, etc. by applying a poly fill and PTFE coated e-glass fabric patch or a PTFE coated e-glass fabric wrap to both synthetic polymer and/or non-synthetic polymer surfaces to fill a crack, or to apply the PTFE coated e-glass fabric or the pipe or tank, or to create a poly sheet that restores the surface of pipes and tanks. The method comprises the steps of, roughing the polymer pipe or tank surfaces with an abrasive to remove any residue, dirt, grease and corrosion followed by cleaning the surface with any cleaner to remove the leftover residues (Step 105); applying a polymer preparation solution over the obtained polymer pipe or tank surfaces until the saturation is achieved (Step 110); allowing the applied polymer preparation solution to dry onto the polymer pipe or tank surfaces (Step 120); applying the activator/accelerator onto the damaged pipe or tank surfaces and letting the activator/accelerator dry (Step 130); applying a thin layer of SI (Surface Insensitive) bonding agent to the PTFE coated e-glass fabric patch or wrap area (Step 140); applying the PTFE coated e-glass fabric patch or wrap obtained in step 140 onto the pipe or tank surfaces (Step 150); applying pressure onto the PTFE coated e-glass fabric patch or wrap to compress the SI bonding agent into a thin interfacial film having a thickness in the range of about 10–50 microns (Step 160); running the beads of Surface Insensitive (SI) bonding agent onto the top of the PTFE coated e-glass fabric patch or wrap , after each application, spreading the SI bonding agent, and repeating the steps for at least twice (Step 170); spraying the SI bonding agent with activator/ accelerator (Step 180); running the beads of the SI bonding agent onto the top of PTFE coated e-glass fabric patch or wrap and spreading the SI bonding agent (Step 190); spraying the poly fill onto the surface obtained in step 190 (Step 200); brushing or blowing the excess poly fill off the damaged surface (Step 210); repeating steps 140 - 210 until a desired thickness is obtained (Step 220); applying and spreading the last layer of SI bonding agent to the restored surface and then spraying the surface with the solvent-based Activator/Accelerator (Step 230); and heating the restored surface until surface temperature reaches between about 47.5° - 48.8° Celsius necessary to start an exothermic chemical reaction (Step 240).

### BRIEF DESCRIPTION OF DRAWINGS

The present invention will be better understood after reading the following detailed description of the presently preferred aspects thereof with reference to the appended drawings, in which the features, other aspects and advantages of certain exemplary embodiments of the invention will be more apparent from the accompanying drawing in which:

FIG. 1 is a flowchart depicting a method of repairing pipe or tank surfaces using a poly fill and coated fabric.

### DETAILED DESCRIPTION OF THE INVENTION

The following description describes various features and functions of the disclosed system with reference to the accompanying figures. In the figures, similar symbols identify similar components, unless context dictates otherwise. The illustrative aspects described herein are not meant to be limiting. It may be readily understood that certain aspects of the disclosed system can be arranged and combined in a wide variety of different configurations, all of which have not been contemplated herein.

Accordingly, those of ordinary skill in the art will recognize that various changes and modifications of the embodiments described herein can be made without departing from the scope of invention. In addition, descriptions of well-known functions and constructions are omitted for clarity and conciseness.

Features that are described and/or illustrated with respect to one embodiment may be used in the same way or in a similar way in one or more other embodiments and/or in combination with or instead of the features of the other embodiments.

The terms and words used in the following description are not limited to the bibliographical meanings but are merely used to enable a clear and consistent understanding of the invention. Accordingly, it should be apparent to those skilled in art that the following description of exemplary embodiments of the present invention are provided for illustrative purposes only and not for the purpose of limiting the invention.

It is to be understood that the singular forms “a”, “an” and “the” include plural referents unless the context clearly dictates otherwise.

It should be emphasized that the term “comprises/comprising” when used in this specification is taken to specify the presence of stated features, steps or components but does not preclude the presence or addition of one or more other features, steps, components or groups thereof.

The term “polymer” and “synthetic polymer” may be interchangeably used in the present disclosure.

The term “non-polymer” and “non-synthetic polymer” may be interchangeably used in the present disclosure.

Accordingly, the present invention relates to a method of repairing pipe and tank surfaces using poly fill and PTFE coated e-glass fabric. Particularly, the present invention relates to a method for repairing damage in pipes, tanks, etc. by applying a PTFE coated e-glass fabric patch or a PTFE coated e-glass fabric wrap to restore the capacity, integrity and usability of damaged pipes and a poly fill comprising of polymer micro-balloons to both synthetic polymer and/or non-synthetic polymer pipe and tank surfaces to restore the structural integrity of cracked surfaces, or to create a poly sheet that restores the surface of damaged pipes and tanks.

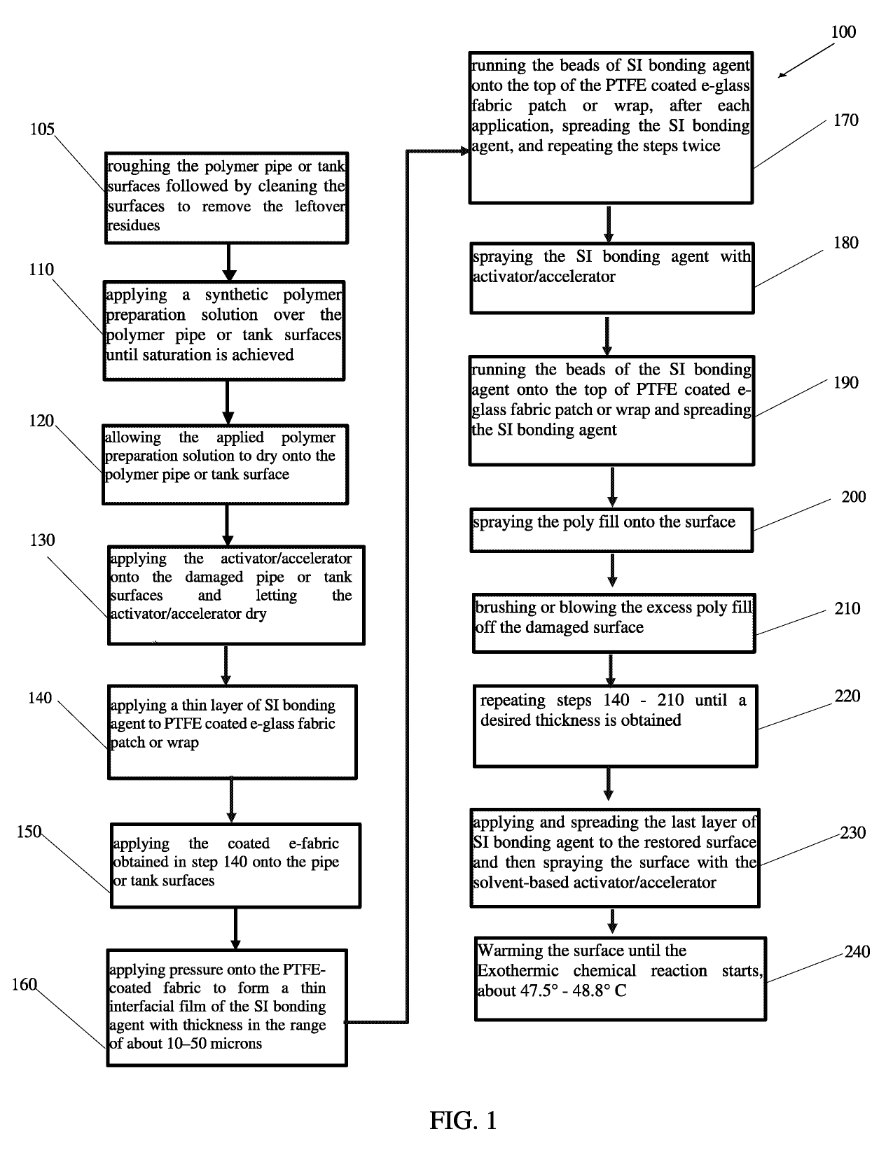

In an embodiment, as shown in FIG. 1, the method of repairing pipe and tank surfaces using poly fill and coated fabric comprises the steps of:
(a) roughing the polymer pipe or tank surfaces with an abrasive to remove any residue, dirt, grease, and corrosion followed by cleaning the surface with any cleaner to remove the leftover residues (Step 105);
(b) applying a synthetic polymer preparation solution over the polymer pipe or tank surfaces obtained in step 105 until the saturation is achieved (Step 110);
(c) allowing the applied polymer preparation solution to dry onto the polymer pipe or tank surfaces (Step 120);
(d) applying the activator/accelerator onto the damaged pipe or tank surfaces and letting the activator/accelerator dry (Step 130);
(e) applying a thin layer of SI bonding agent to PTFE coated e-glass fabric patch or wrap (Step 140);
(f) applying the PTFE coated e-glass fabric patch or wrap obtained in step 140 onto the pipe or tank surfaces (Step 150).
(g) applying pressure onto the PTFE coated e-glass fabric patch or wrap to compress the SI bonding agent into a thin interfacial film with thickness in the range of about 10–50 microns; (Step 160)
(h) running the beads of SI bonding agent onto the top of the PTFE coated e-glass fabric patch or wrap, after each application, spreading the SI bonding agent, and repeating the steps for at least twice (Step170);
(i) spraying the SI bonding agent with activator/accelerator (Step 180);
(j) running the beads of the SI bonding agent onto the top of PTFE coated e-glass fabric patch or wrap and spreading the SI bonding agent (Step 190);
(k) spraying the poly fill onto the surface obtained in step 190 (Step 200);
(l) brushing or blowing the excess poly fill off the damaged surface (Step 210);
(m) repeating steps 140 - 210 until the desired thickness is obtained (Step 220);
(n) applying and spreading the last layer of SI bonding agent to the restored surface and then spraying the surface with the solvent-based activator/accelerator (Step 230); and
(o) heating the restored surface until surface temperature reaches between about 47.5° - 48.8° Celsius to start exothermic chemical reaction (Step 240).

In an exemplary embodiment, the material for polymer/synthetic polymer may be selected from a group of poly-plastics consisting of, such as, but not limited to, oil-based polymers, co-polymers and polyolefins, or a combination thereof. In another exemplary embodiment, the poly-plastics may be selected from the group of polymers consisting of, such as, but not limited to, low-density polyethylene (LDPE), high density polyethylene (HDPE), polypropylene (PP), Polyvinyl chloride (PVC) Polystyrene (PS), Nylon, Thermoplastic polyurethanes (TPU), Polytetrafluoroethylene (PTFE), Silicones, and Polysiloxanes, or a combination thereof.

The synthetic polymer preparation solution (PPS) used in step 110 is a chemical composition, which helps prepare the synthetic polymer surface for the molecular integration process. The synthetic polymer preparation solution comprises of chemical compounds, enabling achievement of high strength bonds when utilized in conjunction with bonding agent. In an exemplary embodiment, the synthetic polymer preparation solution comprises 95-99% of hydrotreated light naphtha, 3-5% of isopropanol, and 0.1-1.0% of triethylenediamine wherein Naphtha is a flammable liquid hydrocarbon mixture and known as Petroleum ether. It belongs to the product category of UVCB s-Organic. Naphtha is a group of various volatile, highly flammable, liquid hydrocarbon mixtures used chiefly as nonpolar solvents. Chemically, it is not an ether like diethyl ether, but a light hydrocarbon. Naphtha (petroleum), hydrotreated light is obtained from petroleum refineries as the portion of the distillate, which is intermediate between the lighter naphtha and the heavier kerosene. Naphtha (petroleum), hydrotreated light consists mainly of pentane, and sometimes used instead of pentane due to its lower cost; Isopropanol or isopropyl alcohol is a compound with the chemical formula C₃H₈O. Isopropyl alcohol is a colorless, flammable chemical compound with a strong odor. As an isopropyl group linked to a hydroxyl group, it is the simplest example of a secondary alcohol, where the alcohol carbon atom is attached to two other carbon atoms. It is a structural isomer of 1-propanol. The isopropyl compound is preferred because it is a solvent for non-polar materials such as poly-plastics, thus when applied to the poly-plastic surface, the compound preferably etches the surface providing a superior surface structure framework for the molecular integration; and triethylenediamine is an organic compound with the formula N₂(C₂H₄)₃, a highly nucleophilic amine, which is used as a catalyst and reagent in polymerization and organic synthesis. Triethylenediamine is an active ingredient in the PPS, which provides a catalyst during the polymerization bonding process.

In an exemplary embodiment, the drying technique used in step 120 may vary depending upon the ambient conditions. For instance, under normal conditions, air drying may be sufficient to dry the applied polymer preparation solution onto the polymer pipe or tank surfaces; and in environments with high humidity or surface moisture, a heat gun may be used to ensure the pipe or tank surface is completely dry before proceeding to subsequent steps. Controlled heating not only removes residual moisture but also extends the effective working time, allowing additional time to properly position and apply the patch or wrap

In an exemplary embodiment, the SI bonding agent used in steps 140, 170-190, and 230 may be selected from a group of cyanoacrylate consisting of, such as, but not limited to, methyl 2-cyanoacrylate, ethyl-2-cyanoacrylate, n-butyl cyanoacrylate 2-octyl cyanoacrylate.

Cyanoacrylate surface bonding agent are sometimes known generically as instant glues, power glues or superglues. The abbreviation “CA” is commonly used for industrial grades. The active ingredient in cyanoacrylate surface bonding agent is cyanoacrylate ester. Typical cyanoacrylate bonding agent compounds are comprised of 90-99% cyanoacrylate ester. Preferably, the cyanoacrylate surface bonding agent is a surface insensitive bonding agent, which is formulated to react much faster than traditional CA's on inactive and active surfaces, even in dry climates, for a more consistent, reliable bond. This effect is magnified when a surface insensitive CA is used on polymer substrates in combination with the synthetic polymer preparation solution.

In another exemplary embodiment, the PTFE coated e-glass fabric used in step 140 and 150 is PTFE coated e-glass fabric patch or wrap, which provides the pipe and tank surfaces resistance to chemicals, oil, gas, solvent, aromatic fuels, weather and UV radiation.

In an exemplary embodiment, the SI bonding agent applied onto the PTFE coated e-glass fabric patch or wrap in step 140 is in a minimal amount sufficient to achieve complete and uniform coverage of the bonding surface. The SI bonding agent is spread into a thin, continuous film, avoiding pooling or excess material. When the patch or wrap is pressed into place, the SI bonding agent forms a compressed interfacial layer, with performance determined by complete surface coverage rather than material thickness or volume.

In an embodiment, the thickness of the thin interfacial film formed in step 160 may vary with surface roughness, viscosity grade, and applied pressure while remaining within a thin-film regime rather than forming a bulk bonding agent layer. In a preferred embodiment, the thickness of the thin interfacial film is in the range of about 15–30 microns.

In another exemplary embodiment, the poly fill used in step 200 comprises poly beads (poly micro-balloons), and a polymerization catalyst. In an exemplary embodiment, the polymerization catalyst may be selected from a group, consisting of, such as, but not limited to, sodium bicarbonate. In another exemplary embodiment, the ratio of micro-balloon may be 50-80% and sodium bicarbonate may be 20-50%. The poly beads used in a crack in HDPE pipe will restore the structural integrity of the crack. The poly beads (poly micro-balloons) are tiny pieces of polypropylene or a similar polymer. Their tiny size allows for the heat, the catalyst and the SI bonding agent to 3D print a result. In a yet another exemplary embodiment, the size of poly beads may be approximately 1.5 microns. The poly fill used as a poly sheet increases the thickness of the pipe or tank. This increased thickness adds strength and durability to the pipe or tank.

In an exemplary embodiment, the poly fill sprayed onto the surface in step 200 has a thickness in the range of approximately 10 to 50 microns, sufficient to provide uniform coverage over the SI bonding agent layer.

In an exemplary embodiment, the poly fill is sprayed onto the surface in step 200 through manual means selected from, such as, but not limited to, an air gun for larger surface areas, or a hand-spray bulb for smaller surface areas.

In an embodiment, the poly fill comprising of polymer micro-balloons and a catalyst are used to fill cracks in the outer wall of the pipe and to restore the structural integrity of the pipe. In another embodiment, the Poly Fill can be used to 3D print a poly sheet onto both polymer, non-polymer pipe and tank surfaces. With polymer substrates, the created poly sheet provides surface area and increases the strength of the pipe or tank surfaces. With steel, this poly sheet restores the required corrosion allowance in the depleted steel walls of an oil and gas storage tank.

In an exemplary embodiment, the activator/ accelerator used in steps 130, 180 and 230 may be selected from a group consisting of, such as, but not limited to, solvent-based accelerator, or heptane-based accelerator. In another exemplary embodiment, the accelerator comprises 3% - 4% of polymerization catalyst and 96% - 97% of acetone The poly fill, an accelerator, a surface insensitive cyanoacrylate structural bonding agent, and heat in combination create a poly sheet that covers the damaged surface of the pipe or tank. The polymerization catalyst is a chemical composition comprising an amine for activating, accelerating, and intensifying the polymerization bonding process of the cyanoacrylate structural bonding agent. Preferably, the amine used may be N, N-Dimethyl-p-toluidine with chemical formula C₉H₁₃N and is miscible with alcohol, ether, and chloroform as a carrier substance. The polymerization catalyst enhances the alkaline conditions on the treated surface in order to activate and accelerate the intensity of the polymerization of the cyanoacrylate structural bonding agent or formation of covalent bonds.

In an exemplary embodiment, the activator/accelerator is applied onto the damaged pipe or tank surfaces using a technique such as, but not limited to, spraying.

In another embodiment, the activator/accelerator applied onto the damaged pipe or tank surfaces in step 130 is in the form of a thin, discontinuous to semi-continuous layer. In an exemplary embodiment, the thickness of activator/accelerator coated onto the damaged pipe or tank surfaces is approximately 1 to 20 microns, sufficient to condition the surface without forming a bulk liquid layer.

In an exemplary embodiment, the drying technique used in step 130 may vary depending upon the ambient conditions. For instance, under normal conditions, ambient air drying may be sufficient to dry the applied activator/accelerator onto the damaged pipe or tank surfaces; and in environments with elevated humidity or surface moisture, drying may be assisted using a handheld heat gun or equivalent low-temperature heating device. In such cases, the surface may be warmed only as needed to remove residual moisture, typically to a surface temperature below approximately 50°C, for a duration sufficient to achieve a visibly dry surface, generally ranging from seconds to a few minutes. Drying may be considered complete when no visible moisture remains on the surface, and thus prolonged heating is not required.

In an exemplary embodiment, a glue squeegee or a plastic putty knife is used to apply pressure onto the PTFE coated in step 160, and to spread SI bonding agent in step 170 and 190.

In an embodiment, the number of beads of SI bonding agent in step 170 depends on the patch size to ensure complete coverage upon spreading. For instance, patches of 2 to 3 inches in width may require approximately 4 to 6 beads. In another exemplary embodiment, the SI bonding agent applied onto the top of the PTFE coated e-glass fabric patch or wrap in step 170 is in the form of parallel beads spaced approximately ½ inch apart.

In an exemplary embodiment, the activator/accelerator sprayed onto the SI bonding agent in step 180 is in a minimal spray amount sufficient to form continuous, unbroken contact with the SI bonding agent, enabling propagation of the exothermic reaction along the bond line.

In an exemplary embodiment, the desired thickness of each layer of PTFE-coated e-glass fabric patch or wrap in step 220 may be approximately 1 millimeter. In another embodiment, the number of layers and resulting overall repair thickness may be selected based on the extent of damage, repair application, pressure requirements, and structural integrity needs of the specific pipe or tank application. For instance, a single layer providing a thickness of approximately 1 mm may be sufficient; two layers providing a combined thickness of approximately 2 mm may be applied in some other applications; three or four layers may be applied in fewer applications requiring enhanced structural reinforcement, providing a combined thickness of approximately 3 mm to 4 mm, respectively.

In an alternate embodiment, the method may be applicable for non-polymer pipe or tank surfaces wherein the step of preparation and application of polymer preparation solution may be eliminated.

In another embodiment, the present invention provides a kit for repairing damaged pipe or tank surfaces using a poly fill and PTFE coated e-fabric. The kit comprising of a quantity of synthetic polymer preparation solution; a quantity of PTFE-coated e-glass fabric patches or wraps; a quantity of poly fill; an accelerator; a quantity of surface insensitive cyanoacrylate structural bonding agent; and an instructions manual for using the synthetic polymer preparation solution, e-coated fabric, poly fill, accelerator, and the surface insensitive cyanoacrylate structural bonding agent to produce the permanent bond with the pipe or tank surfaces.

In another embodiment, the quantities of the synthetic polymer preparation solution, PTFE coated e-glass fabric patches or wraps, poly fill, activator/accelerator, and surface insensitive cyanoacrylate structural bonding agent provided in the kit may vary depending upon the intended application, ranging from small repair kits suitable for individual repairs to bulk volumes suitable for industrial use. For instance, an economy kit may comprise a PTFE coated e-glass fabric patch of approximately 3 inches by 3 inches, approximately 10 ml of surface insensitive cyanoacrylate structural bonding agent, approximately 0.5 ounce of activator/accelerator, and approximately 0.75 ounces of synthetic polymer preparation solution. In another embodiment, a large industrial kit may comprise up to 3,000 square inches of PTFE coated e-glass fabric patch material, approximately 32 ounces of surface insensitive cyanoacrylate structural bonding agent, approximately 1 liter of activator/accelerator, approximately 1 gallon of synthetic polymer preparation solution, and approximately 10 pounds of poly fill.

### EXAMPLES

The following exemplary embodiments are described below to illustrate the method of repairing pipe and tank surfaces using poly fill and PTFE coated e-glass fabric. These examples are provided for illustrative purposes and should not be construed as limiting the scope of the invention.

### Example 1

Repairing pipe and tank surfaces using poly fill and PTFE coated e-glass fabric: With an HDPE pipe with a crack in the surface, 1) rough the surface of the pipe and rough the interior sides of the crack. 2)Then clean the surfaces, removing all residue. 3) Saturate the surface and the crack. Let dry. 3) Apply an SI bonding agent to both wall of the crack from top to bottom. 4) Blow the Poly Fill into the crack. 5) Repeat 3) and 4) until the crack is filled 6) Sand the Poly Fill till it is smooth to the pipe surface. 7) Saturate that area with the Poly Prep. Let dry. 8) Spray the entire area with the Accelerator. Let dry. 9) Apply the SI Cyanoacrylate to the PTFE-coated e-glass fabric in a thorough, but not heavy, manner. 10) Press the PTFE-coated e-glass fabric onto the pipe substrate. 11) Apply pressure to the patch or wrap. 11) Run beads of the Cyanoacrylate on top of the fabric 12) Spread the Cyanoacrylate with a glue squeegee 13) Repeat 11 and 12 twice) 14) Spray the Cyanoacrylate with the Accelerator. A polymer shield has been formed over the repaired tank. Alternate 12) Sprinkle or Spray the Poly fill onto the Cyanoacrylate 13 Brush off excess Poly Fill 14) Repeat 11 and Alternate 12 and 13 until the desired thickness is reached. 15) Spray a light mist of the Accelerator on the Poly Fill 16) Warm the surface to about 117-120° F (47-49°C). A poly sheet has been bonded to the substrate.

### Example 2

Polyolefin polymer pipe of tank surfaces is roughened with an abrasive to remove any residue, dirt, grease, and corrosion followed by cleaning the surfaces with any cleaner to remove the leftover residues (Step 105). A polymer preparation solution (comprises of 95-96% of hydrotreated light naphtha, 3-4% of isopropanol, and 0.01-1% of triethylenediamine) is applied over the polyolefin polymer pipe or tank surfaces obtained in step 105 (Step 110) followed by drying onto the pipe of rank surfaces. Afterwards, an activator/accelerator (comprises of 3-5% of N, N-Dimethyl-p-toluidine and 95- 97% of acetone) is applied onto the damaged pipe or tank surfaces and letting the activator/accelerator dry (Step 130). A thin layer of cyanoacrylate bonding agent is applied to PTFE coated e-fabric (Step 140) for coating and the coated e-fabric obtained in step 140 is applied onto the pipe or tank surfaces (Step 150). Pressure is applied onto the PTFE coated fabric (Step 160), and the beads of cyanoacrylate bonding agent are applied onto the top of the coated fabric. After each application, the cyanoacrylate bonding agent is spread, and the step is repeated twice (Step 170). The cyanoacrylate bonding agent is sprayed with activator/accelerator (Step 180) followed by running the beads of the cyanoacrylate bonding agent onto the top of PTFE coated e-glass fabric and spreading the cyanoacrylate bonding agent (Step 190). Next poly fill is prepared using 50% polymer micro-balloons and 50% sodium bicarbonate. The poly fill is sprayed onto the surface obtained in step 190 (Step 200) and brushed or blown the excess poly fill off the damaged surface (Step 210). Steps 140 - 210 are repeated until the desired thickness is obtained (Step 220). The last layer of cyanoacrylate bonding agent is applied and spread to the restored surface and then the surface is sprayed with the solvent-based activator/accelerator (Step 230). Next, the restored surface was heated until surface temperature reached between about 47.5° - 48.8° C to start exothermic chemical reaction (Step 240).

In an embodiment, the PTFE coated e-glass fabric patch or wrap and/or the poly fill applied to the pipe or tank surface may provide anti-corrosion properties to the repaired surface. The applied wrap, patch, or poly fill may act as a protective barrier against moisture and oxygen, which may help eliminate or prevent rust formation on the treated surfaces. This anti-corrosion property may be particularly beneficial for applications involving steel pipes, tanks, or other metallic substrates that are susceptible to rust and corrosion.

The present invention exhibits advantages such as restoring the damaged part of the synthetic polymer or non-synthetic polymer tank and pipe surfaces, providing a flexible patch or wrap effective on the curvature of the pipe or tank, providing a durable patch or wrap effective for a long duration of at least ten years without replacement, and restoring the lost corrosion allowance in the steel storage tanks without welding that contain oil and gas.

While this invention has been described in connection with what is presently considered to be the most practical and preferred embodiment, it is to be understood that the invention is not limited to the disclosed embodiments but, on the contrary, is intended to cover various modifications and equivalent arrangements included within the scope of the appended claims.

We claim:

1. A method of repairing damaged pipe and tank surfaces using poly fill and PTFE coated e-fabric comprising the steps of:
(a) roughing the polymer pipe or tank surfaces with an abrasive to remove any residue, dirt, grease, and corrosion followed by cleaning the surfaces with any cleaner to remove the leftover residues (Step 105);
(b) applying a polymer preparation solution over the polymer pipe or tank surfaces obtained in step 105 (Step 110) until the saturation is achieved;
(c) allowing the applied polymer preparation solution to dry onto the polymer pipe or tank surfaces (Step 120);
(d) applying the activator/accelerator onto the damaged pipe or tank surfaces and letting the activator/accelerator dry (Step 130);
(e) applying a thin layer of SI bonding agent to the PTFE-coated e-fabric (Step 140);
(f) applying the coated e-fabric obtained in step 140 onto the pipe or tank surfaces (Step 150).
(g) applying pressure onto the PTFE-coated fabric to form a thin interfacial film of the SI bonding agent with thickness in the range of about 10–50 microns; (Step 160)
(h) running the beads of SI bonding agent onto the top of the PTFE coated e-glass fabric patch or wrap, after each application, spreading the SI bonding agent, and repeating the steps twice (Step 170);
(i) spraying the SI bonding agent with activator/accelerator (Step 180);
(j) running the beads of the SI bonding agent onto the top of PTFE coated e-glass fabric patch or wrap and spreading the SI bonding agent (Step 190);
(k) spraying the poly fill onto the surface obtained in step 190 (Step 200);
(l) brushing or blowing the excess poly fill off the damaged surface (Step 210);
(m) repeating steps 140 - 210 until the desired thickness is obtained (Step 220);
(n) applying and spreading the last layer of SI bonding agent to the restored surface and then spraying the surface with the solvent-based activator/accelerator (Step 230); and
(o) heating the restored surface until surface temperature reaches between about 47.5° - 48.8°C to start exothermic chemical reaction (Step 240).

2. The method of claim 1, wherein the polymer preparation solution comprises 95-99% of hydrotreated light naphtha, 3-5% of isopropanol, and 0.1-1.0% of triethylenediamine.

3. The method of claim 1, wherein the SI bonding agent is cyanoacrylate selected from a group of methyl 2-cyanoacrylate, ethyl-2-cyanoacrylate, n-butyl cyanoacrylate and 2-octyl cyanoacrylate.

4. The method of claim 1, wherein the poly fill comprises poly micro-balloons and a polymerization catalyst.

5. The method of claim 4, wherein the polymerization catalyst is sodium bicarbonate and the ratio of polymer micro-balloons is 50-80% and sodium bicarbonate is 20-50%.

6. The method of claim 1, wherein the poly fill sprayed onto the surface in step 200 has a thickness in the range of approximately 10 to 50 microns.

7. The method of claim 1, wherein the poly fill in step 200 is sprayed onto the surface through manual means selected from a group consisting of an air gun for larger surface areas, and a hand-spray bulb for smaller surface areas.

8. The method of claim 1, wherein the activator/accelerator comprises 3% to 4% of polymerization catalyst and 96% to 97% of acetone.

9. The method of claim 8, wherein the polymerization catalyst is N, N-Dimethyl-p-toluidine.

10. The method of claim 1, wherein a glue squeegee or a plastic putty knife is used to apply pressure onto the PTFE coated in step 160, and to spread SI bonding agent in step 170 and 190.

11. The method of claim 1, wherein the number of beads of SI bonding agent in step 170 depends on the patch size to ensure complete coverage upon spreading.

12. The method of claim 1, wherein the SI bonding agent applied onto the top of the PTFE coated e-glass fabric patch or wrap in step 170 is in the form of parallel beads spaced approximately ½ inch apart.

13. The method of claim 1, wherein the method is used for non-polymer pipe or tank surfaces, wherein steps (b) and (c) are eliminated.

14. The method of claim 1, wherein the polymer preparation solution applied on the polymer pipe or tank in step 110 is dried using air drying under normal ambient conditions, or heat gun drying under high humidity or surface moisture conditions.

15. The method of claim 1, wherein the activator/accelerator is applied onto the damaged pipe or tank surfaces using a technique such as, but not limited to, spraying.

16. The method of claim 1, wherein the activator/accelerator applied onto the damaged pipe or tank surfaces in step 130 is in the form of a thin, discontinuous to semi-continuous layer with thickness of approximately 1 to 20 microns, sufficient to condition the surface without forming a bulk liquid layer.

17. The method of claim 1, wherein the activator/accelerator applied on the damaged pipe or tank surfaces in step 130 is dried using ambient air drying under normal conditions, or using a handheld heat gun or equivalent low-temperature heating device under elevated humidity or surface moisture conditions, with the surface warmed to a temperature below approximately 50°C.

18. The method of claim 1, wherein the desired thickness of each layer of PTFE-coated e-glass fabric patch or wrap in step 220 is approximately 1 millimeter.

19. The method of claim 18, wherein the number of layers is selected based on the extent of damage, repair application, pressure requirements, and structural integrity needs of the specific pipe or tank application.

20. A kit for repairing damaged pipe or tank surfaces using a poly fill and PTFE coated e-fabric, comprising:
a quantity of synthetic polymer preparation solution;
a quantity of PTFE coated e-fabric;
a quantity of poly fill comprising polymer micro-balloons and a polymerization catalyst;
an activator/ accelerator;
a quantity of surface insensitive (SI) bonding agent; and
an instructions manual for using the synthetic polymer preparation solution, PTFE coated fabric, poly fill, accelerator, and the surface insensitive bonding agent to produce a permanent bond with the pipe or tank surfaces.

21. The kit of claim 20, wherein the synthetic polymer preparation solution comprises 95-99% of hydrotreated light naphtha, 3-5% of isopropanol, and 0.1-1.0% of triethylenediamine.

22. The kit of claim 20, wherein the SI bonding agent is cyanoacrylate selected from a group of methyl 2-cyanoacrylate, ethyl-2-cyanoacrylate, n-butyl cyanoacrylate and 2-octyl cyanoacrylate.

23. The kit of claim 20, wherein the poly fill comprises polymer micro-balloons in a range of 60-80% and a polymerization catalyst in a range of 20-40%.

24. The kit of claim 20, wherein the activator/accelerator comprises 3% to 4% of polymerization catalyst and 96% to 97% of acetone.
